(19) United States
(12) Patent Application Publication
(10) Pub. No.: US 2010/0209657 A1
(43) Pub. Date: Aug. 19, 2010

(54) WEAR-PROOF PLATE STRUCTURE FOR A SIDE SHEET OF CONTAINER BODY

(75) Inventors: T.H. HUANG, Qingdao City (CN); Robert WANG, Qingdao City (CN); Ryan XU, Qingdao City (CN); Eric SHAN, Qingdao City (CN)

Correspondence Address: CANTOR COLBURN, LLP, 20 Church Street, 22nd Floor, Hartford, CT, 06103, US

(73) Assignees: CHINA INTERNATIONAL MARINE CONTAINERS (GROUP) LTD., Guangdong (CN); QINGDAO CIMC REEFER TRAILER CO., LTD., Qingdao (CN); QINGDAO CIMC REEFER CONTAINER MANUFACTURE CO., LTD, Qingdao (CN); QINGDAO CIMC SPECIAL REEFER CO., LTD., Qingdao (CN)

(21) Appl. No.: 12/700,776

(22) Filed: Feb. 5, 2010

(30) Foreign Application Priority Data
Feb. 19, 2009 (CN) 200920009775.X

(51) Int. Cl. B32B 3/06

(52) U.S. Cl. 428/99

(57) ABSTRACT

A wear-proof plate structure for a side sheet of a container body comprises a wear-proof plate with a wavy cross-section and an angular bottom corner seal connected with the wear-proof plate. The wear-proof plate has a body part with at least 2 full waves. An upper end of the body part is of wave peak and provided with an interface slot which opens upward and is connected with a lower end of an internal sheet of the container side sheet by plug connection. A lower end of the wear-proof plate is of wave trough and extends to form a planar connection board. A bending portion at lower end of the wear-proof plate is provided with a plug-in slot which opens toward a wave trough direction and is connected with an upper end of a vertical part of the bottom corner seal by plug connection. Holes for mounting fastening screws are arranged in a connection board at the lower end of the wear-proof plate. According to the present invention, the number of the fasteners reduces, and the amount of moisture in the container body entering the insulation layer through the fastener gaps is significantly reduced. As a result, by applying the wear-proof plate structure of the present invention, it is possible to improve the heat insulation effect of the container body and reduce the energy consumption.

### FIELD OF THE INVENTION

The present invention relates to a wear-proof plate structure for a side sheet of a thermal or refrigerated container or for a side sheet of a van transporter body.

### BACKGROUND OF THE INVENTION

Nowadays, thermal and refrigerated containers as well as thermal, refrigerated, or dry van transporter are extensively used internationally, and such transportation facilities are being used increasingly domestically. The refrigerated, thermal or dry van, van trailer, semi-trailer body and refrigerated or thermal container body in the related art include a floor sheet 8, as well as a left side sheet, a right side sheet, a front end sheet, and a rear end sheet mounted on the floor sheet 8. Each of the two side sheets respectively consists of an external sheet 1 and an internal sheet 2 with an insulation layer 3 sandwiched between them. The external sheet 1 is provided with reinforcing ribs 11. A reinforcing wooden board 4 is provided in the insulation layer 3. To prevent the container side sheet from damages during the forklift's entering the container body as well as during cargo handling, and to prevent further effects on the heat insulation and refrigeration performance of the whole container body, it is usually required to mount the wear-proof plate to a certain height at the lower end of the body internal sheet to protect the container body.

In the current market, there exist wear-proof plate structures like an integral aluminum profile wear-proof plate, an integral nonmetallic composite wear-proof plate, and a split aluminum profile wear-proof plate. The height of the integral wear-proof plate is fixed. However, in consideration of weight, cost and cargo type, the customers always require different height of wear-proof plate. The manufacturers of transportation facilities usually have to manufacture wear-proof plates of different heights to meet the demand of different customers. Nevertheless, wear-proof plates of a certain height take a relatively low utilization ratio in the market, which leads to waste imperceptibly. Especially for an aluminum profile wear-proof plate, it is required to form different aluminum profile molds according to the requirements on the height. This leads to a great waste, increases the development cost and period, and further impairs the products' market competitiveness.

As show in FIGS. 1 and 2, a split aluminum profile wear-proof plate structure in the related art includes several wear-proof plates 5 with wavy cross-sections mounted on an internal sheet 2 and a bottom corner seal 7 mounted at the junction between the internal sheet 2 and the floor sheet 8. In practice, an appropriate number of wear-proof plates 5 are selected according to the desired height of wear-proof. The upper and lower ends of each wear-proof plate 5 are fixed to the side sheet by a row of fasteners like fastening screws 6, self tapping screw, or rivet, respectively. The two adjacent wear-proof plates 5 are butt jointed. In the traditional wear-proof plate structure, the two neighboring rows of fasteners on the two adjacent wear-proof plates 5 are relatively close to each other, which tends to degrade the strength of the container side sheet and reduce the service life of container body. Besides, moisture in the container body may enter the insulation layer 3 through the gaps of these mounting fastener and the butt gaps between two wear-proof plates 5 during operation, and the heat insulation effect of the insulation layer 3 will become worse. The transported cargos are usually required to maintain at a low constant temperature environment. The worse the heat insulation effect for the container body, the more refrigeration energy the refrigerating unit should provide, and the higher the energy consumption. In addition, with the intrusion of the moisture, the insulation layer 3 will become heavier. As for transportation facilities, provided that the gross transport weight is constant, larger dead weight will reduce the allowable weight of cargos, i.e. influence the carrying capacity of the transportation facilities.

Therefore, it is urgent to design a wear-proof plate structure which can reduce the energy consumption of the container body.

### SUMMARY OF THE INVENTION

In view of the drawbacks in the related art, it is an object of the present invention to provide a wear-proof plate structure which can improve the heat insulation effect of the container body.

The following solution is adapted in the present invention to achieve the above object.

The present invention provides a wear-proof plate structure for a side sheet of a container body, comprising a wear-proof plate with a wavy cross-section and an angular bottom corner seal connected with the wear-proof plate. The wear-proof plate has a body part with at least one full wave. An upper end of the body part is of wave peak and provided with an interface slot which opens upward and is connected with a lower end of an internal sheet of the container side sheet by plug connection; a lower end of the wear-proof plate is of wave trough and extends to form a planar connection board. A bending portion at lower end of the wear-proof plate is provided with a plug-in slot which opens toward a wave trough direction and is connected with an upper end of a vertical part of the bottom corner seal by plug connection. Holes for mounting fastening screws are arranged in the connection board at the lower end of the wear-proof plate.

An outer bottom surface of the interface slot, an outer bottom surface at the wave trough of the body part, and an outer bottom surface of the connection board of the wear-proof plate lie in the same plane.

The vertical part of the bottom corner seal has a bending part toward the container body side sheet, and the bending part is integrally connected with a plug board. An upper end of the plug board is formed with a plug connector which matches the plug-in slot. The plug board contacts and engages the connection board at lower portion of the wear-proof plate.

The wear-proof plate structure further comprises at least one lower wear-proof plate which is connected in series between the wear-proof plate and the bottom corner seal by plug connection. Each lower wear-proof plate includes a body part with at least one full wave; an upper end of the body part is of wave trough, and is integrally formed with a plug board. An upper end of the plug board is integrally formed with a plug connector toward the wave peak direction. A lower end of the body part is of wave trough position and extends to form a planar connection board. At bending portion of lower end of the lower wear-proof plate, a plug-in slot is provided toward the wave trough direction and parallel with the bending part. The plug-in slot at the lower portion of the wear-proof plate is connected with the plug connector at the upper end of the adjacent lower wear-proof plate by plug connection. For every two adjacent lower wear-proof plates, the plug connector of the underlying lower wear-proof plate is connected with the plug-in slot of the above lower wear-proof plate by plug connection. The plug board of each lower wear-proof plate contacts and engages the connection board of the above lower wear-proof plate. Holes for mounting fastening screws are arranged in the connection board at the lower end of each lower wear-proof plate.

An outer bottom surface of the connection board of the lower wear-proof plate and that of wave trough part of the body part lie in the same plane, and the outer bottom surface of the plug board and an inner bottom surface of the wave trough part lie in the same plane.

The length of the connection board of the wear-proof plate is larger than that of the plug board of the lower wear-proof plate, and holes of the wear-proof plate for mounting the fastening screws are arranged in a portion of the connection board which extends beyond the plug board. The length of the connection board of the lower wear-proof plate is larger than that of the plug board, and larger than that of the plug board of the bottom corner seal. Holes of the lower wear-proof plate for mounting each fastening screw are arranged in a portion of each connection board which extends beyond the plug board that contacts and engages the connection board, or in a portion which extends beyond the plug board, respectively.

Junctions among the wear-proof plate, each lower wear-proof plate and the bottom corner seal are applied with a sealant.

The wear-proof plate, the lower wear-proof plate and the bottom corner seal are made of aluminum, rubber or polystyrene.

The wear-proof plate structure for a side sheet of a container body according to the present invention has the following advantages and positive effects. In the present invention, the upper wear-proof plate, the lower wear-proof plate and the angular bottom corner seal which constitute the wear-proof plate structure are connected by plug connection. There exist overlapped portion between the upper wear-proof plate and the lower wear-proof plate, between two adjacent lower wear-proof plates, or between the lower wear-proof plate and the bottom corner seal, which helps to prevent the moisture in the container body from entering the insulation layer of the side sheet. In addition, such a plug connection has certain connection strength, so that it is only required to arrange a row of holes for fastening screws in the upper wear-proof plate or in each lower wear-proof plate. That is, a row of fastening screws can fix them firmly to the side sheet of the container, the number of the fasteners reduces, and thereby the amount of moisture in the container body entering the insulation layer through the fastener gaps is significantly reduced. As a result, by applying the wear-proof plate structure of the present invention, it is possible to improve the heat insulation effect of the container body and reduce the energy consumption.

The above and other objects, features and advantages of the present invention will be more apparent from the following detailed description of preferred embodiments taken in conjunction with the accompanying drawings.

### BRIEF DESCRIPTION OF THE DRAWING

FIG. 1 is a structural view showing a split aluminum profile wear-proof plate structure in the related art;

FIG. 2 is a schematic view showing a split aluminum profile wear-proof plate structure in the related art which is mounted onto an internal sheet of a container side sheet;

FIG. 3 is a structural view showing an upper wear-proof plate in a wear-proof plate structure of the present invention;

FIG. 4 is a structural view showing a lower wear-proof plate in the wear-proof plate structure of the present invention;

FIG. 5 is a structural view showing a bottom corner seal in the wear-proof plate structure of the present invention;

FIG. 6 is a structural view showing the wear-proof plate structure of the present invention;

FIG. 7-1 is a structural view showing a first step of mounting the wear-proof plate structure of the present invention on the internal sheet;

FIG. 7-2 is a structural view showing a second step of mounting the wear-proof plate structure of the present invention on the internal sheet;

FIG. 7-3 is a structural view showing a third step of mounting the wear-proof plate structure of the present invention on the internal sheet;

FIG. 7-4 is a structural view showing a fourth step of mounting the wear-proof plate of the present invention on the internal sheet; and

FIG. 7-5 is a structural view showing a fifth step of mounting the wear-proof plate structure of the present invention on the internal sheet.

### DESCRIPTION OF THE PREFERRED EMBODIMENTS

The specific embodiments of the present invention will be described in detail thereafter. It should be noted that the embodiments described herein are intended to illustrate but not to limit the present invention.

In the present invention, in a state that a wear-proof plate structure has been mounted on a side sheet of a container body, the direction toward a floor sheet 8 along the vertical direction is defined as a downward direction, and the direction away from the floor sheet 8 along the vertical direction is defined as an upward direction; the direction toward the side sheet is defined as a wave trough direction of the wavy wear-proof plate, and the direction away from the side sheet is defined as a wave peak direction.

As show in FIG. 6, the wear-proof plate structure of the present invention includes a wear-proof plate 20, a bottom corner seal 30, and three lower wear-proof plates 10 with a wavy cross-section between the wear-proof plate 20 and the bottom corner seal 30. The number of the lower wear-proof plate 10 depends on the wear-proof height of the container, and is not limited to three. If a relatively large wear-proof height is required, the number of the lower wear-proof plate 10 increases correspondingly. If a relatively small wear-proof height is required, the number of the lower wear-proof plate 10 decreases correspondingly, and it is even possible to omit the lower wear-proof plate 10 and directly connect the wear-proof plate 20 and the bottom corner seal 30 by plug connection. The two adjacent lower wear-proof plates 10 are connected together at their ends by plug connection, and are fixed to the side sheet of the container body by fasteners like fastening screws 6, self tapping screw, etc. The upper end of the wear-proof plate 20 is connected with the internal sheet of the side sheet by plug connection, and the lower end is connected with the adjacent lower wear-proof plate 10 by plug connection. The vertical part of the bottom corner seal 30 is connected with the adjacent lower wear-proof plate 10 by plug connection, and the horizontal part is soldered onto the floor sheet 8.

In the present invention, the wear-proof plate 20, the lower wear-proof plate 10, and the bottom corner seal 30 can be made of aluminum, rubber, polystyrene, or other composite materials. The plug junctions among the wear-proof plate 20, the lower wear-proof plate 10 and the bottom corner seal 30 are applied with a sealant. This helps to prevent moisture in the container body from entering the insulation layer of the side sheet through plug gaps.

As shown in FIGS. 4 and 6, each of the lower wear-proof plates 10 includes a body part with 3 full waves. The number of the full wave is not limited to 3, but can also be 1, 2, 4, or 5. An upper end of the body part is of wave trough, and is formed with a plug board 12 which is integrated with the body part. The upper end of the plug board 12 is formed with a plug connector 13 which is integrated with the plug board 12 and toward the wave peak direction. The angle between the plug connector 13 and the plug board 12 is an obtuse angle, which helps to reduce the plug resistance. The lower end of the body part of the lower wear-proof plate 10 is of wave trough, and extends to form a planar connection board 22. A plug-in slot 23 toward the wave trough direction is provided at the bending portion of the lower end of the lower wear-proof plate 10. The outer bottom surface (i.e. the bottom surface close to the container side sheet) of the connection board 22 and that of the wave trough part of the body part lie in the same plane. The outer bottom surface of the plug board 12 and the inner bottom surface of the wave trough part of the body part lie in the same plane, namely the distance between the outer bottom surface of the plug board 12 and that of the connection board 22 is equal to the thickness of the connection board 22. In this way, an elastic force exerting outwards will not occur once the wear-proof plate structure is mounted, so that the wear-proof plate is more firmly fixed to the side sheet and will not loosen for a long-term.

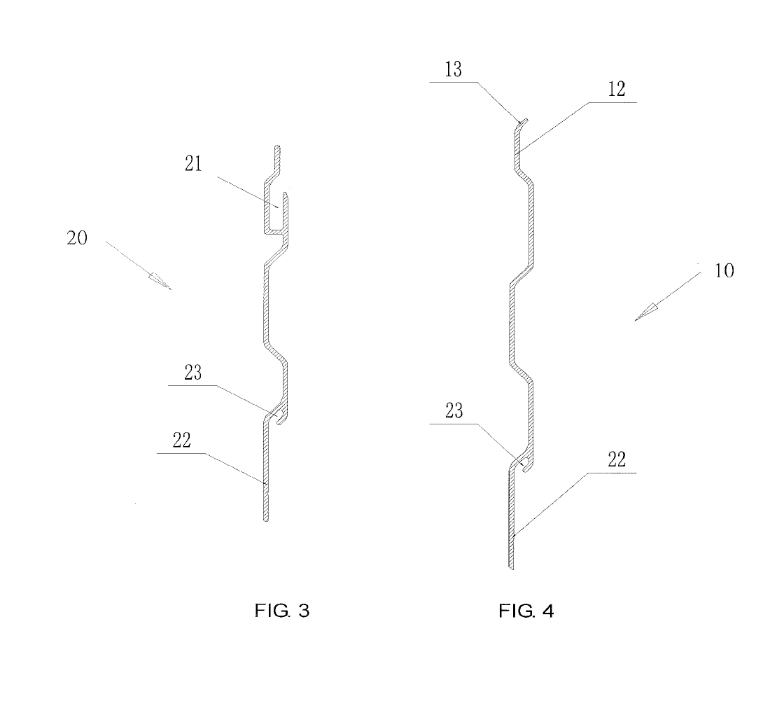

As show in FIGS. 3 and 6, each wear-proof plate 20 has a body part with 2 full waves. The number of the full wave is not limited to 2, but can also be 1, 3, or 4. An upper end of the body part is of wave peak, provided with an interface slot 21 which opens upward, and connected with a lower end of the internal sheet of the container side sheet by plug connection. The lower end of the wear-proof plate 20 is of wave trough, and extends to form a planar connection board 22. A plug-in slot 23 toward the wave trough direction is provided at the bending portion of the lower end of the wear-proof plate 20, and is connected with the upper end of the vertical part of the bottom corner seal 30 by plug connection. The outer bottom surface of the interface slot 21, the outer bottom surface of the wave trough of the body part, and the outer bottom surface of the connection board 22 lie in the same plane. The connection board 22 at the lower end of the wear-proof plate 20 is provided with holes for mounting the fastening screws 6.

The plug connector 13 at the upper end of the lower wear-proof plate 10 matches the plug-in slot 23 at the lower end of the wear-proof plate 20 or the plug-in slot 23 at the lower end of the above lower wear-proof plate 10. The plug board 12 at the upper portion of the lower wear-proof plate 10 contacts and engages the connection board 22 at the lower end of the wear-proof plate 20, or the connection board 22 at the lower end of the above lower wear-proof plate 10.

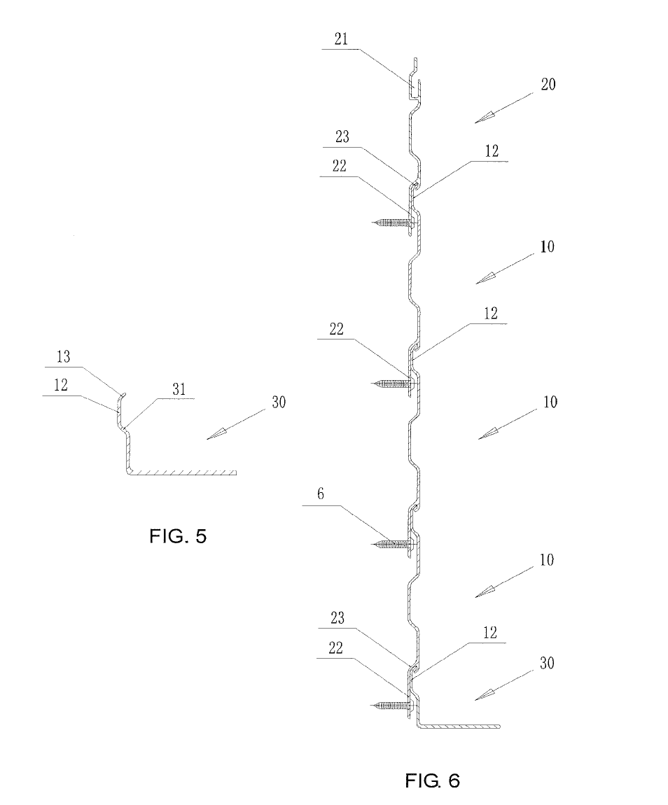

As show in FIGS. 5 and 6, the bottom corner seal 30 is right-angled, and its vertical part has a bending part 31 toward the container side sheet. The bending part 31 is connected with the plug board 12, which contacts and engages the connection board 22 at the lower end of the adjacent lower wear-proof plate 10. An upper end of the plug board 12 is formed with a plug connector 13 which forms an obtuse angle with the plug board 12, and the plug connector 13 matches the plug-in slot 23 at the lower portion of the adjacent lower wear-proof plate 10.

The outer bottom surface of the wave trough of the body part of the wear-proof plate 20, the outer bottom surface of the connection board 22 of the wear-proof plate 20, the outer bottom surface of the interface slot 21 of the wear-proof plate 20, the outer bottom surface of the wave trough of the body part of the lower wear-proof plate 10, the outer bottom surface of the connection board 22 of the lower wear-proof plate 10 lie in the same plane, which makes it very convenient to mount.

As show in FIG. 6, the length of the connection board 22 at the lower end of the wear-proof plate 20 is larger than that of the plug board 12 of the lower wear-proof plate 10 which contacts and engages with the connection board 22, and holes for mounting the fastening screws 6 of the wear-proof plate 20 are arranged in a portion of the connection board 22 which extends beyond the plug board 12. Consequently, the fastening screws 6 can be covered by the body part of the lower wear-proof plate 10. Similarly, the length of the connection board 22 at the lower end of each lower wear-proof plate 10 is larger than that of the plug board 12 at the upper portion, and holes for mounting the fastening screws 6 of the lower wear-proof plate 10 are arranged in the extending portion of the connection board 22. In this way, when the two adjacent lower wear-proof plates 10 are connected by plug connection, the fastening screws 6 for securing the above lower wear-proof plate 10 can be covered by the body part of the underlying lower wear-proof plate 10. The length of the connection board 22 of the lower wear-proof plate 10 at the lowest end is larger than that of the plug board 12 of the bottom corner seal 30 which contacts and engages the connection board 22, holes for mounting the fastening screws 6 of the lower wear-proof plate 10 are arranged in the extending portion of the connection board 22, and the fastening screws 6 are covered by the plug board 12 of the angular bottom corner seal.

In the present invention, each fastening screw 6 is covered by the lower wear-proof plate 10 or the bottom corner seal 30 and thus is not exposed. Therefore, on one hand, the fastening screws 6 are prevented from rusting and damaging, and the firmness of mounting the wear-proof plate structure on the container side sheet is improved. On the other hand, more importantly, it is possible to prevent moisture in the container from entering the insulation layer through the fastener gaps, further improve the heat insulation effect of the container body, and further help to reduce the dead weight of the container body.

The wear-proof plate structure according to the present invention is applicable to the container side sheet of thermal and refrigerated container, side sheet of thermal, refrigerated, dry van transporter body, side sheet of general container, and side sheets of various containers.

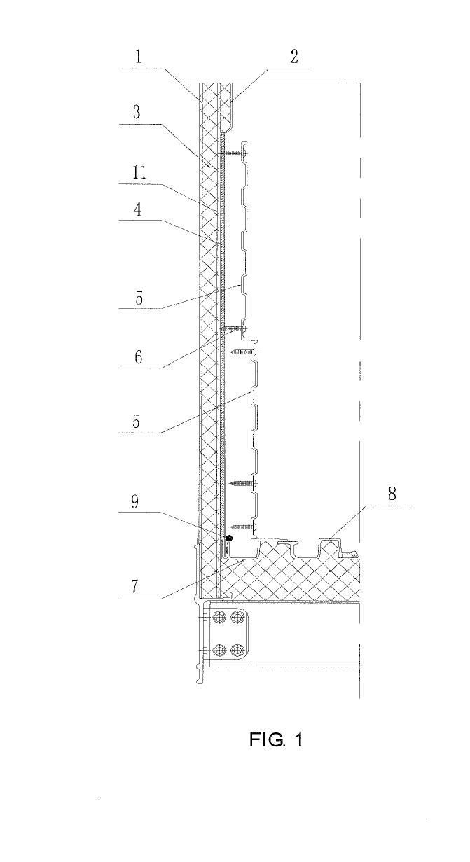

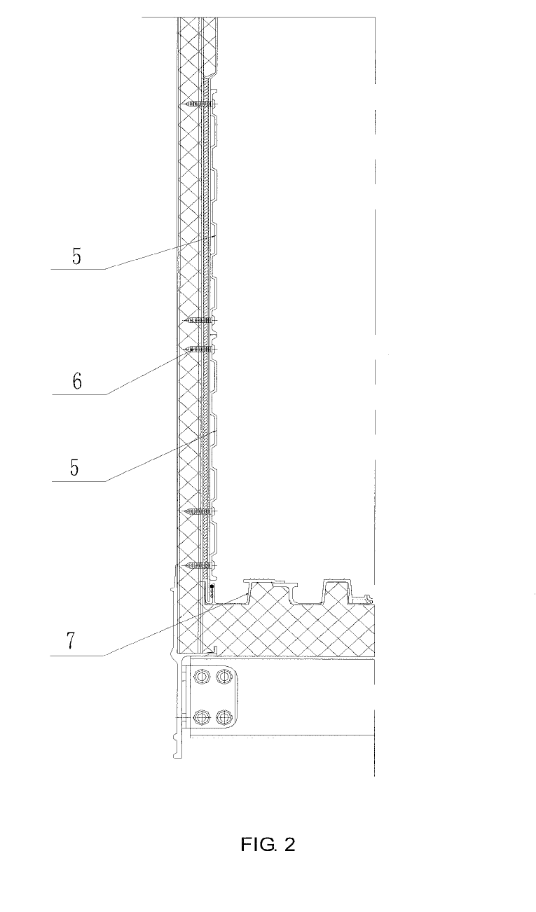

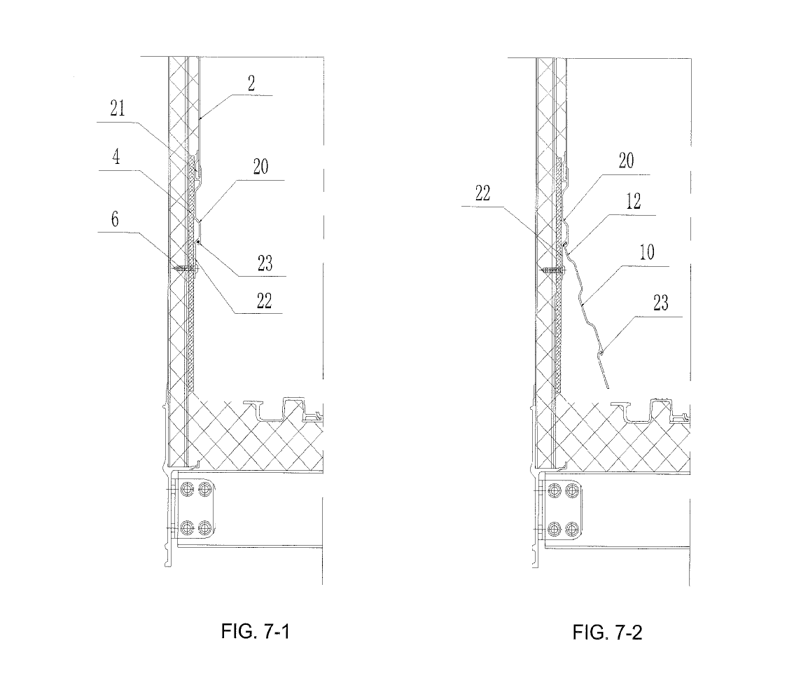

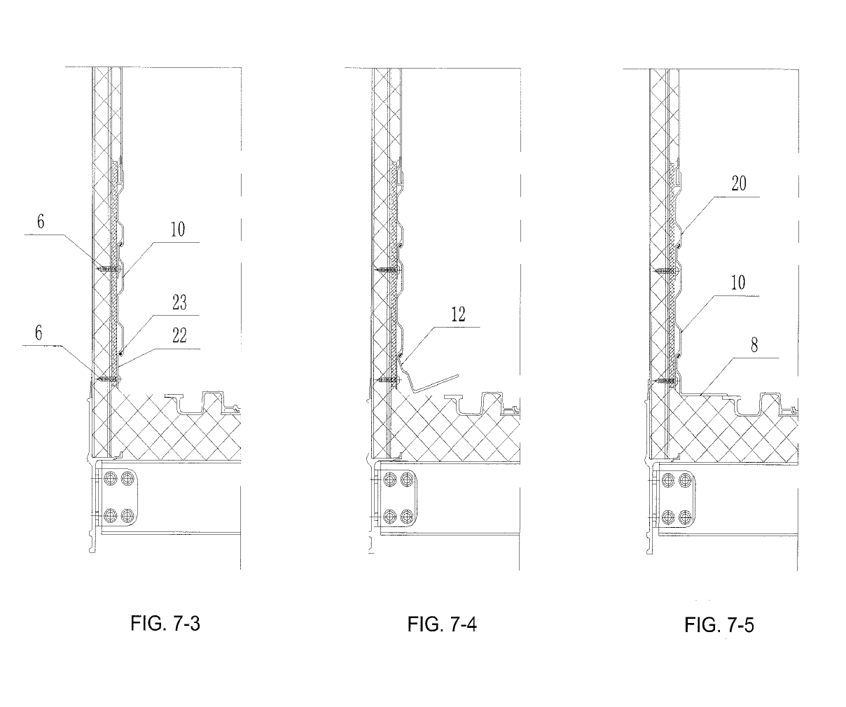

As show in FIGS. 7-1 to 7-5, the wear-proof plate structure of the present invention is mounted according to the following procedure.

Firstly, the upper wear-proof plate 20 is to be mounted. A structural adhesive is applied to the inside of the interface slot 21 of the upper wear-proof plate 20 which contacts the internal sheet 2, so that the lower end of the internal sheet 2 is inserted into the interface slot 21 and is stuck by the structural adhesive. The upper wear-proof plate 20 is secured to the reinforcement plate 4 within the side sheet by fastening screws 6 which pass through the holes at the lower portion of the connection board 22 of the upper wear-proof plate 20. The mounting of the upper wear-proof plate 20 is completed in this way.

Secondly, the lower wear-proof plate 10 is to be mounted. A sealant is applied to the plug-in slot 23 of the upper wear-proof plate 20. The plug connector at the upper end of the lower wear-proof plate 10 is rotated into the plug-in slot 23 of the upper wear-proof plate 20, and the plug board 12 of the lower wear-proof plate 10 contacts and engages the connection board of the upper wear-proof plate 20. The lower wear-proof plate 10 is secured to the reinforcement plate within the side sheet by fastening screws 6 which pass through holes at the lower portion of the connection board 22 of the lower wear-proof plate 10. The mounting of a piece of lower wear-proof plate 10 is completed in this way.

Finally, the bottom corner seal 30 is to be mounted. A sealant is applied into the plug-in slot 23 of the lower wear-proof plate 10, the plug connector of the bottom corner seal 30 is rotated into the plug-in slot 23 at the lower portion of the wear-proof plate 10, so that the plug board 12 contacts and engages the connection board 22. A horizontal part of the bottom corner seal 30 is soldered to the floor sheet 8 of container. In this way, the assembly of a wear-proof plate structure constituted by an upper wear-proof plate 20, a lower wear-proof plate 10, and a bottom corner seal 30 is completed, which can meet the demand for a 12″ wear-proof plate.

If the container side sheet requires a relatively small wear-proof height, it is not necessary to mount the lower wear-proof plate 10, and the bottom corner seal 30 is directly connected with the upper wear-proof plate 20, which can meet the demand for a 6″ wear-proof plate. If a relatively large wear-proof height is required, another lower wear-proof plate 10 can be mounted according to the above mentioned procedure. For example, a wear-proof plate structure constituted by an upper wear-proof plate 20, two lower wear-proof plates 10, and a bottom corner seal 30 can meet the demand for an 18″ wear-proof plate. Addition of a further lower wear-proof plate 10 will make such a wear-proof plate structure meet the demand for a 24″ wear-proof plate. Wear-proof plate structures with such wear-proof heights can basically cover the market demand.

In the present invention, the connection among the upper wear-proof plate, the lower wear-proof plate, and the angular bottom corner seal which constitute the wear-proof plate structure are all realized by plug connection, which helps to prevent moisture in the container body from entering the insulation layer of the side sheet. In addition, such a plug connection has certain connection strength, so that it is only necessary to arrange a row of holes for fastening screws in the upper wear-proof plate or in each lower wear-proof plate to fix them firmly to the container side sheet. The number of the fasteners reduces by a half, and the amount of moisture in the container body entering the insulation layer through the fastener gaps is significantly reduced. Therefore, by applying the wear-proof plate structure of the present invention it is possible to significantly improve the heat insulation effect of the container body. At the same time, since the number of the fasteners reduces, it is also possible to improve the strength of the side sheet and guarantee the carrying capacity of the transportation facilities. Wear-proof plate structures with different wear-proof heights can be manufactured by increasing or decreasing the number of the lower wear-proof plate, so that it is possible to reduce the production cost and shorten the development period. Besides, the wear-proof plate structure is simple and can be easily manufactured and mounted.

While the present invention has been described in connection with certain embodiments, it will be understood that the terms herein illustrate rather than limit the present invention. The present invention can be practiced in many particular embodiments without departing from the spirit and scope of the present invention, and thus it will be appreciated that the above embodiments should not be limited to any details described above, but should be interpreted broadly with the spirit and scope defined by the appended claims. The appended claims intend to cover all the modifications and changes falling within the scope of the appended claims and equivalents thereof.

What is claimed is:

1. A wear-proof plate structure for a side sheet of a container body, which comprises a wear-proof plate with a wavy cross-section and an angular bottom corner seal connected with the wear-proof plate, wherein the wear-proof plate has a body part with at least one full wave, an upper end of the body part is of wave peak and provided with an interface slot which opens upward and is connected with a lower end of an internal sheet of the container side sheet by plug connection; a lower end of the wear-proof plate is of wave trough and extends to form a planar connection board; a bending portion at lower end of the wear-proof plate is provided with a plug-in slot which opens toward a wave trough direction and is connected with an upper end of a vertical part of the bottom corner seal by plug connection; and holes for mounting fastening screws are arranged in the connection board at the lower end of the wear-proof plate.

2. The wear-proof plate structure according to claim 1, wherein an outer bottom surface of the interface slot, an outer bottom surface at a wave trough of the body part, and an outer bottom surface of the connection board of the wear-proof plate lie in the same plane.

3. The wear-proof plate structure according to claim 2, wherein the vertical part of the bottom corner seal has a bending part toward the container body side sheet, the bending part is integrally connected with a plug board, an upper end of the plug board is formed with a plug connector which matches the plug-in slot, and the plug board contacts and engages the connection board at lower portion of the wear-proof plate.

4. The wear-proof plate structure according to claim 1, further comprising at least one lower wear-proof plate which is connected in series between the wear-proof plate and the bottom corner seal by plug connection; each lower wear-proof plate includes a body part with at least one full wave; an upper end of the body part is of wave trough and is integrally formed with a plug board, an upper end of the plug board is integrally formed with a plug connector toward the wave peak direction; a lower end of the body part is of wave trough and extends to form a planar connection board; at bending portion of lower end of the lower wear-proof plate, a plug-in slot is provided toward the wave trough direction and parallel with the bending; the plug-in slot at the lower portion of the wear-proof plate is connected with the plug connector at the upper end of the adjacent lower wear-proof plate by plug connection; for every two adjacent lower wear-proof plates, the plug connector of the underlying lower wear-proof plate is connected with the plug-in slot of the above lower wear-proof plate by plug connection; the plug board of each lower wear-proof plate contacts and engages the connection board of the above lower wear-proof plate; and holes for mounting fastening screws are arranged in the connection board at the lower end of each lower wear-proof plate.

5. The wear-proof plate structure according to claim 2, further comprising at least one lower wear-proof plate which is connected in series between the wear-proof plate and the bottom corner seal by plug connection; each lower wear-proof plate includes a body part with at least one full wave; an upper end of the body part is of wave trough and is integrally formed with a plug board, an upper end of the plug board is integrally formed with a plug connector toward the wave peak direction; a lower end of the body part is of wave trough and extends to form a planar connection board; at bending portion of lower end of the lower wear-proof plate, a plug-in slot is provided toward the wave trough direction and parallel with the bending; the plug-in slot at the lower portion of the wear-proof plate is connected with the plug connector at the upper end of the adjacent lower wear-proof plate by plug connection; for every two adjacent lower wear-proof plates, the plug connector of the underlying lower wear-proof plate is connected with the plug-in slot of the above lower wear-proof plate by plug connection; the plug board of each lower wear-proof plate contacts and engages the connection board of the above lower wear-proof plate; and holes for mounting fastening screws are arranged in the connection board at the lower end of each lower wear-proof plate.

6. The wear-proof plate structure according to claim 3, further comprising at least one lower wear-proof plate which is connected in series between the wear-proof plate and the bottom corner seal by plug connection; each lower wear-proof plate includes a body part with at least one full wave; an upper end of the body part is of wave trough and is integrally formed with a plug board, an upper end of the plug board is integrally formed with a plug connector toward the wave peak direction; a lower end of the body part is of wave trough and extends to form a planar connection board; at bending portion of lower end of the lower wear-proof plate, a plug-in slot is provided toward the wave trough direction and parallel with the bending; the plug-in slot at the lower portion of the wear-proof plate is connected with the plug connector at the upper end of the adjacent lower wear-proof plate by plug connection; for every two adjacent lower wear-proof plates, the plug connector of the underlying lower wear-proof plate is connected with the plug-in slot of the above lower wear-proof plate by plug connection; the plug board of each lower wear-proof plate contacts and engages the connection board of the above lower wear-proof plate; and holes for mounting fastening screws are arranged in the connection board at the lower end of each lower wear-proof plate.

7. The wear-proof plate structure according to claim 4, wherein an outer bottom surface of the connection board of the lower wear-proof plate and that of wave trough part of the body part lie in the same plane, and the outer bottom surface of the plug board and an inner bottom surface of the wave trough part lie in the same plane.

8. The wear-proof plate structure according to claim 5, wherein an outer bottom surface of the connection board of the lower wear-proof plate and that of wave trough part of the body part lie in the same plane, and the outer bottom surface of the plug board and an inner bottom surface of the wave trough part lie in the same plane.

9. The wear-proof plate structure according to claim 6, wherein an outer bottom surface of the connection board of the lower wear-proof plate and that of wave trough part of the body part lie in the same plane, and the outer bottom surface of the plug board and an inner bottom surface of the wave trough part lie in the same plane.

10. The wear-proof plate structure according to claim 7, wherein the length of the connection board of the wear-proof plate is larger than that of the plug board of the lower wear-proof plate, and holes of the wear-proof plate for mounting the fastening screws are arranged in a portion of the connection board which extends beyond the plug board; the length of the connection board of the lower wear-proof plate is larger than that of the plug board, and larger than that of the plug board of the bottom corner seal; and holes of the lower wear-proof plate for mounting each fastening screws are arranged in a portion of each connection board which extends beyond the plug board that contacts and engages the connection board, or in a portion which extends beyond the plug board, respectively.

11. The wear-proof plate structure according to claim 8, wherein the length of the connection board of the wear-proof plate is larger than that of the plug board of the lower wear-proof plate, and holes of the wear-proof plate for mounting the fastening screws are arranged in a portion of the connection board which extends beyond the plug board; the length of the connection board of the lower wear-proof plate is larger than that of the plug board, and larger than that of the plug board of the bottom corner seal; and holes of the lower wear-proof plate for mounting each fastening screws are arranged in a portion of each connection board which extends beyond the plug board that contacts and engages the connection board, or in a portion which extends beyond the plug board, respectively.

12. The wear-proof plate structure according to claim 9, wherein the length of the connection board of the wear-proof plate is larger than that of the plug board of the lower wear-proof plate, and holes of the wear-proof plate for mounting the fastening screws are arranged in a portion of the connection board which extends beyond the plug board; the length of the connection board of the lower wear-proof plate is larger than that of the plug board, and larger than that of the plug board of the bottom corner seal; and holes of the lower wear-proof plate for mounting each fastening screws are arranged in a portion of each connection board which extends beyond the plug board that contacts and engages the connection board, or in a portion which extends beyond the plug board, respectively.

13. The wear-proof plate structure according to claim 4, wherein junctions among the wear-proof plate, each lower wear-proof plate and the bottom corner seal are applied with a sealant.

14. The wear-proof plate structure according to claim 13, wherein the wear-proof plate, the lower wear-proof plate and the bottom corner seal are made of aluminum, rubber or polystyrene.
